(19) United States
(12) Patent Application Publication
(10) Pub. No.: US 2009/0034661 A1
(43) Pub. Date: Feb. 5, 2009

(54) COORDINATE-ASCENT METHOD FOR LINEAR PROGRAMMING DECODING

(76) Inventors: Pascal Olivier Vontobel, Palo Alto, CA (US); Shlrin Jalali, Stanford, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/831,716

(22) Filed: Jul. 31, 2007

(51) Int. Cl. H04L 27/06

(52) U.S. Cl. 375/341

(57) ABSTRACT

A decoder is operable to decode data transmitted on a noisy communication channel. The decoder includes a memory storing bits of encoded data received over the communication channel. The decoder also includes a processor estimating a transmitted codeword from the received bits. The processor is operable to determine a linear program (LP) for decoding the received data, wherein the linear program includes a cost function. A solution to the LP is calculated using a coordinate-ascent method that varies multiple variables associated with the cost function in one iteration. A transmitted codeword is estimated from the received encoded data using the solution to the LP.

### BACKGROUND

A typical, modern, communication system includes a transmitter with an encoder encoding data for transmission on a communication channel to a receiver. The data may be encoded for compression and adding redundancies to correct transmission errors. For example, redundant symbols may be added to the coded information symbols, thus effectively restricting the set of possibly transmitted sequences of symbols to a fraction of all possible sequences. The encoder adds redundant symbols by encoding a message according to a channel coding technique. For example, low-density parity-check (LDPC) codes are often used to encode data.

At the receiver end, errors introduced during transmission, for example, due to a noisy channel, are corrected by a decoder. Thus, decoders are an important part of a reliable, coded, communication system because they ensure data integrity at the receiver.

High throughput is a very desirable feature for many modern communication systems. Decoders in these systems try to quickly correct any errors that were introduced during the transmission. Any delay in decoding may reduce the throughput of the system.

It has recently been proposed that decoding of a code in a decoder can be performed by formulating a linear program (LP) representing the decoding of data and then using conventional linear programming algorithms to solve the LP to decode the data. These “LP decoders”, which use conventional linear programming algorithms to solve the LP, however, would likely be too slow and inefficient to be implemented for many decoding applications. For example, the time it takes to solve the LP may cause the decoding rate of the decoder to be less than conventional decoders. Also, the amount of memory needed to store the data to solve the LP may be much more than in conventional decoders, which may increase the size and cost of the decoder.

### SUMMARY

A decoder is operable to decode data transmitted on a noisy communication channel. The decoder includes a memory storing bits of encoded data received over the communication channel. The decoder also includes a processor estimating a transmitted codeword from the received bits. The processor is operable to determine a linear program (LP) for decoding the received data, wherein the linear program includes a cost function. A solution to the LP is calculated using a coordinate-ascent method that varies multiple variables associated with the cost function in one iteration. A transmitted codeword is estimated from the received encoded data using the solution to the LP.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a communication system, according to an embodiment;

FIG. 2 illustrates a polytope representing solutions to a linear program for decoding data, according to an embodiment;

FIG. 3 illustrates a relaxed polytope of the polytope shown in FIG. 2, according to an embodiment;

FIG. 4 illustrates a Forney-style factor graph (FFG) representing a primal linear program for decoding data, according to an embodiment;

FIG. 5 illustrates an FFG representing a dual linear program for decoding data, according to an embodiment;

FIG. 6 illustrates a flowchart of a method for decoding data, according to an embodiment and

FIG. 7 illustrates a decoder, according to an embodiment.

### DETAILED DESCRIPTION OF THE EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

According to an embodiment, a method for decoding data includes formulating the decoding problem as an LP. The data may have been encoded using low-density parity check (LDPC) code or any other linear or non-linear code. According to an embodiment, a primal LP is formulated and a corresponding dual LP is determined from the primal LP. The dual LP is solved using an improved coordinate-ascent method for decoding the received data at faster rates.

The improved coordinate-ascent method, in one iteration, updates multiple variables. The multiple variables are part of the variables of a cost function that can be represented as a sum of multiple so-called local functions. The cost function may be represented as a Forney-style factor graph (FFG) with function nodes representing the local functions and the edges representing variables such that an edge is incident to a function node if and only if the variable associated to the edge is an argument to the local function associated to the function node. The multiple variables may include all the variables represented by edges incident on a function node in the FFG. The multiple variables are arguments for the particular function represented by the function node. According to an embodiment, all the variables which are associated with edges in the FFG that are incident with a function node are updated in one iteration using the improved coordinate-ascent method. This reduces the number of iterations required to decode the data and hence increases the decoding rate. In one embodiment, the LP is formulated as a dual LP represented by an FFG. The multiple variables include all the variables represented by edges incident to a function node in the FFG representing the cost function in the dual LP.

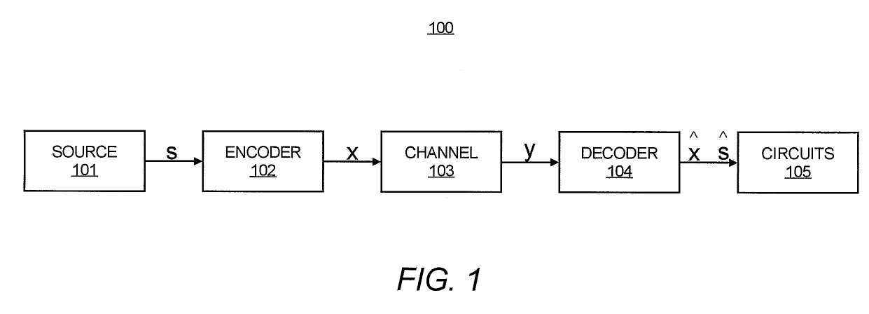

FIG. 1 illustrates an encoding/decoding system 100, according to an embodiment. The system 100 includes an encoder 102 receiving a message from a message source 101 and encoding the message using a code, which may be a linear code such as an LDPC code. Any other linear or non-linear code may also be used. For example, the message source 101 generates a message, shown as “s”. The message s is encoded by the encoder 102. The output of the encoder 102 is a codeword. Conventional encoding is used to encode the message s. In one example, LDPC codes are used to encode the message s. The message source 101 and the encoder 102 may be included in a transmitter or only the encoder 102 may be included in a transmitter transmitting the encoded message s in the system 100.

A codeword x represents the message s. The message s and the codeword x may be represented as follows: s=(s₁, . . . sₖ)∈ S^{k} and x=(x₁, . . . xₙ)∈ C ⊂ Xⁿ. s₁ . . . sₖ are the bits in a message. x₁ . . . xₙ are the bits or symbols of a codeword from code C that can be used to represent a message. n is the number of bits or symbols in a codeword.

The codeword x is transmitted on a communication channel 103 to a receiver including a decoder 104. The decoder 104 receives the sent codeword x, which is shown as y. For example, the channel 103 includes noise, resulting in a received word y that may be different than the sent codeword x. The noisy channel 103 may introduce errors in x. y may be represented as y=(y₁, . . . yₖ)∈ Yⁿ. It should be noted that the communication channel 103 can also represents the whole process of writing and reading of encoded data to a medium for storing encoded data. For example, encoded data may be stored on a computer-readable medium, such as a hard disk, etc. The data is read from the computer-readable medium and decoded by the decoder 104. Some of the data stored on the computer-readable medium may become corrupted over time. The decoder 104 uses the steps described herein to minimize the error of incorrectly estimating the stored data when decoding the data.

The decoder 104 decodes y to estimate the sent codeword x and the message s represented by the sent codeword x. The estimated sent codeword is shown as \hat{x} and the estimated message is shown as ŝ. \hat{x} and ŝ are sent to circuits 105 which may perform further processing on the received message.

A common approach to selecting a decoding rule is to choose the decoding rule that minimizes the probability of decoding to the wrong \hat{x}, i.e., that minimizes Prob(\hat{x}≠x). The resulting rule is known as the blockwise maximum a posteriori (MAP) decoding rule, which can be written as

$${\hat{x}}_{blockMAP} ( y ) = \text{arg} {max}_{x ∈ C} {P}_{x \vert y} ( x \vert y ) .$$

Based on this definition, the codeword x is selected that maximizes the a-posteriori probability of x given the received y. Assuming that all codewords are sent equally likely (a very common assumption), the decision rule becomes what is known as the blockwise maximum-likelihood (ML) decoding rule, which is defined as

$${\hat{x}}_{blockML} ( y ) = \text{arg} {max}_{x ∈ C} {P}_{y \vert x} ( y \vert x ) .$$

Based on this definition, the codeword x is selected that maximizes the probability that y is observed given that x was sent. It was observed in Feldman et al., “Using Linear Programming to Decode Binary Linear Codes”, IEEE Transactions on Information Theory, March 2005, pp. 954-972, (referred to as Feldman et al.), that this equation for ML decoding can be written as Equation 1 as follows:

$${\hat{x}}_{blockML} ( y ) = \text{arg} {min}_{x ∈ C} {\sum }_{i = 1}^{n} {x}_{i} {λ}_{i} \qquad Equation 1$$

Equation 1 indicates that ML decoding can be formulated as finding the codeword x that minimizes the cost function

$${\sum }_{i = 1}^{n} {x}_{i} {λ}_{i} .$$

The decoder 104 selects the codeword x that minimizes the cost function, where

$${λ}_{i} = {λ}_{i} ( {y}_{i} ) = log \frac{{P}_{{y}_{i} \vert {x}_{i}} ( {y}_{i} \vert 0 )}{{P}_{{y}_{i} \vert {x}_{i}} ( {y}_{i} \vert 1 )} .$$

λᵢ is the log-likelihood ratio (LLR) of the i-th bit. The sign of the LLR λᵢ indicates whether the transmitted bit xᵢ is more likely to be a 0 or a 1. If xᵢ is more likely to be 1, then λᵢ is negative. If xᵢ is more likely to be 0, then λᵢ is positive. As further described in Feldman et al., it should be noted that the cost vector λ can be uniformly rescaled by a positive scalar without affecting the solution of the LP decoding problem. For example, for a binary-symmetric channel, it can be assumed that λᵢ=−1 if yᵢ=1, and λᵢ=+1 if yᵢ=0.

Because the cost function

$${\sum }_{i = 1}^{n} {x}_{i} {λ}_{i} .$$

is linear in x and because the set over which the cost function is minimized is discrete, this optimization problem is known as an integer LP.

Equation 1 indicates that to decode binary linear codes, a codeword is found that minimizes the cost function, wherein the cost function is

$${\sum }_{i = 1}^{n} {x}_{i} {λ}_{i} .$$

It can be shown that a solution to Equation 1 is also a solution to the optimization problem represented by Equation 2 as follows:

$${\hat{x}}_{blockML} ( y ) = {\text{arg} min}_{x ∈ conv ( C )} {\sum }_{i = 1}^{n} {λ}_{i} {x}_{i} \qquad Equation 2$$

In Equation 2, conv(C) denotes the convex hull of C. Because the cost function is linear in x and because conv(C) is a polytope (and can therefore be expressed with the help of equalities and inequalities) the optimization problem in Equation 2 is called an LP. Equation 2 indicates that a solution to Equation 1 minimizes the cost function

$${\sum }_{i = 1}^{n} {x}_{i} {λ}_{i}$$

also when the minimum is taken over conv(C) and not just over C. Note that the set of points in conv(C) that minimize the cost function

$${\sum }_{i = 1}^{n} {x}_{i} {λ}_{i}$$

always contains at least one vertex of conv(C), which—by definition—is a codeword. From a practical point, the solution to Equation 1 and Equation 2 are therefore equivalent.

The complexity of solving Equations 1 and 2 is exponential in the block length n for good codes and therefore not feasible for practically relevant block lengths. A standard approach in optimization theory is then to relax the polytope (which is conv(C) in this case) to a relaxed polytope whose description complexity is much lower. Thus, a relaxed polytope is formulated such that the new LP can be solved more easily, yet so that the solution of the new LP is usually close or identical to the solution of the old LP. Equation 2 can also be written as follows:

$${\hat{x}}_{blockML} ( y ) = {\text{arg} min}_{ω ∈ Ω} {\sum }_{i = 1}^{n} {λ}_{i} {ω}_{i} \qquad Equation 3$$

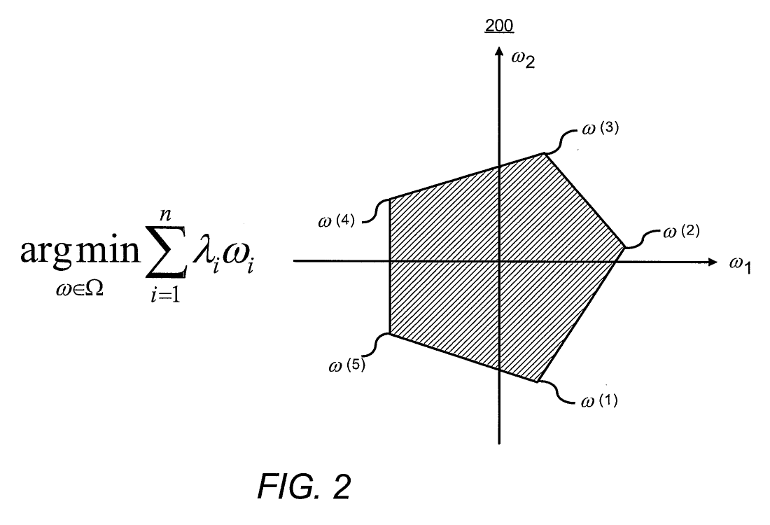

In Equation 3, ω is a point in a polytope Ω and ωᵢ are the components in the vector ω=(ω₁, ω₂, . . . , ωₙ). FIG. 2 illustrates an example of a 2-dimensional polytope 200 representing the solutions to Equations 1 and 2. A vertex in the polytope 200 is a solution to the LP. Some of the vertices are shown as ω⁽¹⁾ to ω⁽⁵⁾. Equation 4 represents the LP with respect to a relaxed polytope.

$${\hat{x}}_{blockML} ( y ) = {\text{arg} min}_{ω ∈ {Ω}^{′}} {\sum }_{i = 1}^{n} {λ}_{i} {ω}_{i} \qquad Equation 4$$

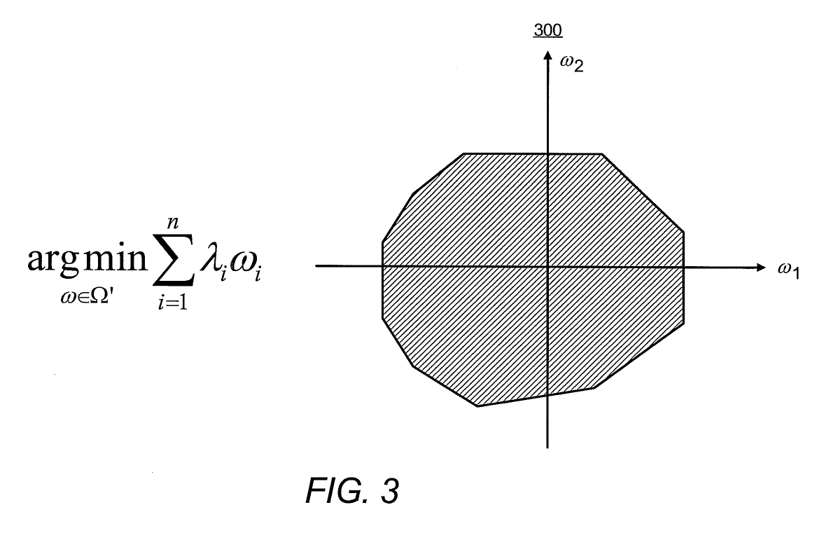

In Equation 4, Ω′ is the relaxed polytope. An example of a relaxation of the polytope 200 is shown in FIG. 3 as the relaxation 300. The relaxation 300 is chosen such that the LP in Equation 4 can be solved more easily yet the solution is close or identical to the solution of the LP in Equation 3.

In the context of decoding, the relaxed polytope is called the fundamental polytope. Such a fundamental polytope can be defined as follows for an LDPC code. An LDPC code is defined using a parity-check matrix as is known in the art. The parity-check matrix may be randomly generated. More importantly, the LDPC code is defined such that a codeword x is in an LDPC code C if the matrix-vector product Hx^{T} equals 0 where H is a parity-check matrix for the code C.

For example, assume a parity-check matrix H is:

$$H = ( \begin{matrix}1 & 1 & 1 & 0 & 0 \\ 0 & 1 & 0 & 1 & 1 \\ 0 & 0 & 1 & 1 & 1\end{matrix} )$$

A codeword x must satisfy the following three conditions: x₁+x₂+x₃=0(mod2); x₂+x₄+x₅=0(mod2); and x₃+x₄+x₅=0(mod2). Thus, C, which is the set of all x's that satisfy those conditions is the intersection of C₁∩C₂∩C₃, where

C₁={x ∈ F₂⁵|h₁x^{T}=0(mod2)}, C₂={x ∈ F₂⁵|h₂x^{T}=0(mod2)}, and C₃={x ∈ F₂⁵|h₃x^{T}=0(mod2)}.

The fundamental polytope P(H) is then defined as shown in Equation 5:

P(H)Δconv(C₁)∩conv(C₂)∩conv(C₃). Equation 5

It can be shown that P(H) is indeed a relaxation of conv(C), i.e., P(H) is a superset of conv(C). Then, the LP decoder is defined as shown in Equation 6:

$${\hat{ω}}_{LP} ( y ) = {\text{arg} min}_{ω ∈ P ( H )} {\sum }_{i = 1}^{n} {λ}_{i} {ω}_{i} \qquad Equation 6$$

Points in the fundamental polytope are referred to as pseudo-codewords herein and in Feldman et al. It will be apparent to one of ordinary skill in the art, that the fundamental polytope may be defined differently and also for non-LDPC codes and even nonlinear codes. The parity-check matrix and the codes C₁-C₃ are provided as an example to illustrate generating a suitable fundamental polytope for defining an LP decoder.

Note that many of the examples and equations herein include a binary linear code C that is defined by a parity-check matrix H of size m by n. Based on H, sets are defined as follows:

$$I = I ( H ) {Δ}_{\underline{\_}} \{ 1 , … , n \} ;$$

$$𝒥 {Δ}_{\underline{\_}} 𝒥 ( H ) {Δ}_{\underline{\_}} \{ 1 , … , m \} ;$$

$${I}_{j} {Δ}_{\underline{\_}} {I}_{j} ( H ) {Δ}_{\underline{\_}} \{ i ∈ I \vert {[ H ]}_{j , i} = 1 \}$$

$$for each$$

$$j ∈ 𝒥 ;$$

$${𝒥}_{j} {Δ}_{\underline{\_}} {𝒥}_{j} ( H ) {Δ}_{\underline{\_}} \{ j ∈ 𝒥 \vert {[ H ]}_{j , i} = 1 \}$$

$$for each$$

$$i ∈ I ;$$

$$ɛ {Δ}_{\underline{\_}} ɛ ( H ) {Δ}_{\underline{\_}} \{ ( i , j ) ∈ I \times 𝒥 \vert i ∈ I , j ∈ {𝒥}_{i} \} = \{ ( i , j ) ∈ I \times 𝒥 \vert j ∈ 𝒥 , i ∈ {I}_{j} \}$$

Moreover, for each j ∈ ℑ, the codes

$${C}_{j} {Δ}_{\underline{\_}} {C}_{j} ( H ) {Δ}_{\underline{\_}} \{ x ∈ {F}_{2}^{n} \vert {h}_{j} {x}^{t} = 0 ( \text{mod} 2 ) \}$$

where hⱼ is the j-th row of H. Note that Cⱼ is a code of length n where all positions not in Iⱼ are unconstrained.

According to an embodiment, the LP described in Equation 6 is called the primal LP and a corresponding dual LP is determined from the primal LP to determine a solution to the LP. Generally, for any (primal) linear programming problem, a so-called dual LP can be formulated. One of the reasons why the dual LP is determined is that the dual LP can be used to derive a solution of the primal LP. Thus, the primal LP in Equation 6 may not be solved directly. Instead, a method is described below for solving the dual LP and from this solution a solution to the primal LP is derived. With regard to the LP described in Equation 6, a corresponding primal LP and a dual LP formulated from the primal LP are described in Vontobel et al., “Towards Low Complexity Linear-Programming Decoding”, Feb. 26, 2006, referred to as Vontobel et al. herein. The primal LP is shown in Equation 7 as follows:

Equation 7: minimize

$${\sum }_{i ∈ I} {λ}_{i} {x}_{i}$$

subject to the following constraints:

$${x}_{i} = {u}_{i , 0} , where ( i ∈ I ) ;$$

$${u}_{i , j} = {v}_{i , j} , where ( ( i , j ) ∈ ɛ ) ;$$

$${\sum }_{{a}_{i} ∈ {A}_{i}} {α}_{i , {a}_{i}} {a}_{i} = {u}_{i} where ( i ∈ I ) . \\ {\sum }_{{b}_{j} ∈ {β}_{j}} {β}_{j , {b}_{j}} {b}_{j} = {v}_{j} where ( j ∈ 𝒥 )$$

$${α}_{i , {a}_{i}} \geq 0 where ( i ∈ I , {a}_{i} ∈ {A}_{i} ) . \\ {β}_{j , {b}_{j}} \geq 0 where ( j ∈ 𝒥 , {b}_{j} ∈ {B}_{j} ) , \\ {\sum }_{{a}_{i} ∈ {A}_{i}} {α}_{i , {a}_{i}} = 1 where ( i ∈ I )$$

$${\sum }_{{b}_{j} ∈ {β}_{j}} {β}_{j , {b}_{j}} {b}_{j} = 1 where ( j ∈ 𝒥 )$$

The code Aᵢ ⊂ {0,1}^{|{0}∪ℑ}^{ᵢ}^{|},i ∈ I, is the set containing the all-zeros vector and the all-ones vector of length |ℑᵢ|+1. Bⱼ ⊂ {0,1}^{|I}^{ⱼ}^{|},j ∈ ℑ, is the code Cⱼ shortened at the positions I\Iⱼ. For (i ∈ I) the vectors uᵢ are used where the entries are indexed by {0} ∪ ℑᵢ and denoted by

$${u}_{i , j} {{Δ}_{\underline{\_}} [ {u}_{i} ]}_{j} ,$$

and for (j ∈ ℑ) the vectors vⱼ are used where the entries are indexed by Iⱼ and denoted by

$${v}_{j , i} {{Δ}_{\underline{\_}} [ {v}_{j} ]}_{i} .$$

Later on, similar notations are used for the entries aᵢ and bⱼ, i.e.,

$${a}_{i , j} {{Δ}_{\underline{\_}} [ {a}_{i} ]}_{j} and {b}_{j , i} {{Δ}_{\underline{\_}} [ {b}_{j} ]}_{i} ,$$

respectively

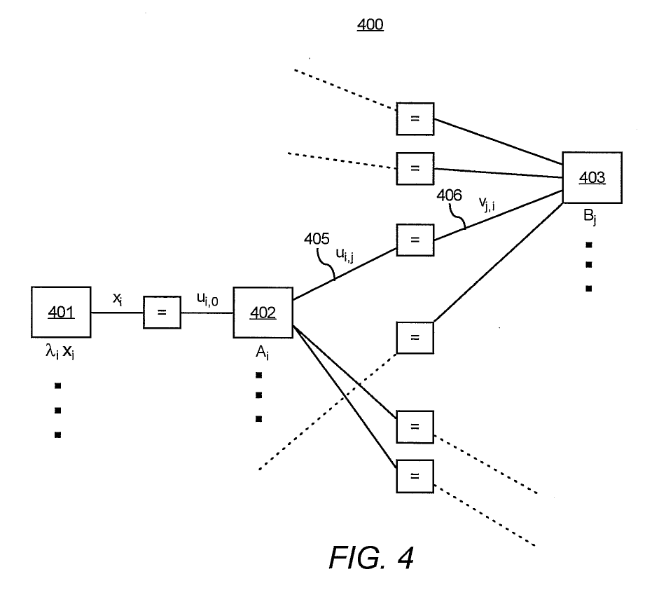

The above optimization problem is elegantly represented by an FFG shown in FIG. 4 and described below. In order to express the LP itself in an FFG, the constraints are expressed as additive cost terms. This is accomplished by assigning the cost +∞ to any configuration of variables that does not satisfy the LP constraints and the cost 0 to configurations of variables that satisfy the LP constraints. The above minimization problem is then equivalent to the (unconstrained) minimization of the augmented cost function as follows:

$${\sum }_{i ∈ I} {λ}_{i} {x}_{i} + {\sum }_{i ∈ I} ‖ {x}_{i} = {u}_{i , 0} ‖ + {\sum }_{( i , j ) ∈ ɛ} ‖ {u}_{i , j} = {v}_{j , i} ‖ + {\sum }_{i ∈ I} {A}_{i} ( {u}_{i} ) + \sum {B}_{j} ( {v}_{j} ) .$$

For all (i ∈ I) and all (j ∈ ℑ), respectively,

$${A}_{i} ( {u}_{i} ) {Δ}_{\underline{\_}} ‖ {\sum }_{{a}_{i} ∈ {A}_{i}} {α}_{i , {a}_{i}} {a}_{i} = {u}_{i} ‖ + {\sum }_{{a}_{i} ∈ {A}_{i}} ‖ {α}_{i , {a}_{i}} \geq 0 ‖ + ‖ {\sum }_{{a}_{i} ∈ {A}_{i}} {α}_{i , {a}_{i}} = 1 ‖ and$$

$${B}_{j} ( {v}_{j} ) {Δ}_{\underline{\_}} ‖ {\sum }_{{b}_{j} ∈ {β}_{j}} {β}_{j , {b}_{j}} {b}_{j} = {v}_{j} ‖ + {\sum }_{{b}_{j} ∈ {β}_{j}} ‖ {β}_{j , {b}_{j}} = 1 ‖ .$$

The expression ∥S∥ means that ∥S∥=0 if the statement S is true and ∥S∥=+∞ otherwise.

An FFG may be used to represent the augmented cost function of the LP shown in Equation 7. FIG. 4 illustrates an FFG 400 of a portion of the augmented cost function of the LP shown in Equation 7. The FFGs described herein represent an additive function whose value equals the sum of the values of the local function nodes, and whose value also equals the value of the augmented cost function of the LP in Equation 7. The FFG 400 shows the local function node λᵢxᵢ on the left side and constraint function nodes on the right side. The complete FFG for the primal LP would include a function node for each local function λᵢxᵢ for i=1 to n along with corresponding edges. Note that a function node 401 represents a function with an argument that is the variable xᵢ, where i=1 to n. The edges corresponding to the variables xᵢ and u_{i,0} are connected by an “=” function node which is an equality function node whose value is ∥xᵢ=u_{i,0}∥. Function nodes 402 and 403 are shown for functions Aᵢ and Bⱼ. Aᵢ and Bⱼ represent the penalty functions associated to the equalities and inequalities for the LP. These function nodes evaluate to either 0 or infinity depending on whether the corresponding equalities and inequalities are satisfied. Also, note that the edges 405 and 406 are connected by an “=” which is an equality function node whose value is ∥u_{i,j}=v_{j,i}∥.

A so-called dual LP can be associated to the primal LP shown in Equation 6. The primal LP and dual LP are different LPs, but a solution to one can often be used to determine a solution for the other. An FFG may be used to represent the dual LP, as described in detail below.

The dual LP is defined by Equation 8 as follows:

Equation 8: maximize

$${\sum }_{i ∈ I} {φ}_{i}^{′} + {\sum }_{j ∈ 𝒥} {θ}_{j}^{′}$$

subject to the following constraints:

$${φ}_{i}^{′} \leq {min}_{{a}_{i} ∈ {A}_{i}} 〈 - {u}_{i}^{′} , {a}_{i} 〉 , where ( i ∈ I ) ;$$

$${θ}_{i}^{′} \leq {min}_{{b}_{j} ∈ Bj} 〈 - {v}_{j}^{′} , {b}_{j} 〉 , where ( j ∈ 𝒥 ) ;$$

$${u}_{i , j}^{′} = - {v}_{j , i}^{′} , where ( ( i , j ) ∈ ɛ ) ; and$$

$${u}_{i , 0}^{′} = - {λ}_{i} , where ( i ∈ I )$$

Used herein, the expression [symbol] vector1, vector2 [symbol] means the inner product of the two vectors, vector1 and vector2. Expressing the constraints as additive cost terms, the above maximization problem is equivalent to the (unconstrained) maximization of the augmented cost function:

$${\sum }_{i ∈ I} {A}_{i}^{′} ( {u}_{i}^{′} ) + {\sum }_{j ∈ 𝒥} {B}_{j}^{′} ( {v}_{j}^{′} ) - {\sum }_{( i , j ) ∈ ɛ} ‖ {u}_{i , j}^{′} = - {v}_{j , i}^{′} ‖ - {\sum }_{i ∈ I} ‖ {u}_{i , 0}^{′} = - {x}_{i}^{′} = - {λ}_{i} ‖ , \\ with$$

$${A}_{i}^{′} ( {u}_{i}^{′} ) = {φ}_{i}^{′} - ‖ {φ}_{i}^{′} \leq {min}_{{a}_{i ∈ {A}_{i}}} 〈 - {u}_{i}^{′} , {a}_{i} 〉 ‖$$

$$and$$

$${B}_{j}^{′} ( {v}_{j}^{′} ) = {θ}_{j}^{′} - ‖ {θ}_{j}^{′} \leq {min}_{{b}_{j ∈ {β}_{j}}} 〈 - {v}_{j}^{′} {b}_{j} 〉 ‖ .$$

Because for each (i ∈ I) the variable φ′ᵢ is involved in only one inequality, the optimal solution does not change if we replace the corresponding inequality signs by equality signs in DLPD2. the same comment holds for all θ′ⱼ,j ∈ ℑ.

In Equation 8,

$${\sum }_{i ∈ I} {φ}_{i}^{′} + {\sum }_{j ∈ 𝒥} {θ}_{j}^{′}$$

represents the cost function. u′ᵢ and v′ⱼ are variables in the dual LP. n is the number of symbols in a codeword. λᵢ is the LLR at each variable node, as described with respect to Equation 1. Since any solution to the dual LP must satisfy u′_{i,j}=−v′_{j,i}, only one set of variables, either {u′ᵢ: i ∈ I} or {v′ⱼ: j ∈ ℑ}, needs to be considered when solving the dual LP to save time and memory space.

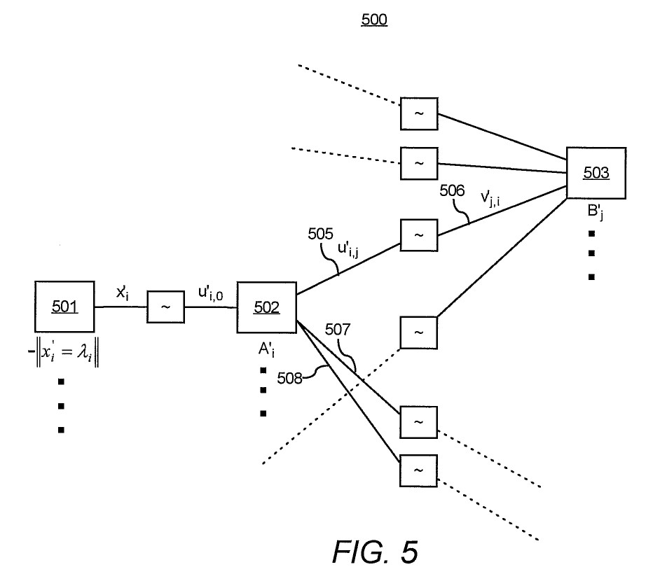

FIG. 5 illustrates an FFG 500 of a portion of the augmented cost function for the dual LP shown in Equation 8. The function node 501 represents the function −∥x′ᵢ=λᵢ∥. Function nodes 502 and 503 represent for the functions A′ᵢ and B′ⱼ as described above. Note that the edges 505 and 506 are connected by a “˜” function node. In the dual LP, a “˜” function nodes means the following: if such a function node is connected to edges u and v then the function value is −∥u=−v∥.

Instead of FFGs, other types of graphs may be used to represent the primal LP of Equation 7 and the dual LP of Equation 8. Graphs, such as a factor graph or a Tanner graph may be used to graphically represent an LP.

A coordinate-ascent method, also referred to as a coordinate-ascent algorithm, may be used to solve the dual LP because the dual LP is solved by determining a maximum of

$${\sum }_{i ∈ I} {φ}_{i}^{′} + {\sum }_{j ∈ J} {θ}_{j}^{′}$$

under the constraints mentioned in Equation 8. Vontobel et al. discloses in Section 6 using a coordinate-ascent type algorithm to solve the dual LP shown in Equation 8. Vontobel et al. discloses that the main idea of using the coordinate-ascent type algorithm to solve the dual LP is to select edges (i,j) ∈ ∈ according to an update schedule. For each selected edge, the old values of u′_{i,j},φ′ᵢ and θ′ⱼ are replaced with new values such that the dual cost function is increased or at least not decreased. For example, referring to FIG. 5, the function node 502 has 3 outgoing edges 505, 507 and 508. In one iteration, one of the edges is selected, such as the edge 505 representing one of the variables u′_{i,j}. All the other variables are fixed, which include the variables represented by the edges 507 and 508. Then, a value for the variable u′_{i,j} represented by the edge 505 is selected such that the dual cost function

$${\sum }_{i ∈ I} {φ}_{i}^{′} + {\sum }_{j ∈ J} {θ}_{j}^{′}$$

is not decreased. Then, in another iteration, another edge is selected, and all the other variables are held fixed. Then, a value for that variable is selected such that the dual cost function is not decreased, and so on for the remaining variables. This can be a relatively time consuming process, especially for large codewords, which may have hundreds or thousands of bits.

According to an embodiment, a coordinate-ascent method is used to solve the dual LP such that multiple variables are varied in a single iteration to determine a solution to the dual LP. Because multiple variables are varied in each iteration, decoding time may be decreased. Also, generally it would not be readily apparent to vary multiple variables in a single iteration of the coordinate ascent function because the calculation would be complex to guarantee that the cost function of the dual LP does not decrease. However, through research and testing, formulations described below have been determined that simplify the solving of the dual LP by selecting particular variables to vary in a single iteration of the coordinate-ascent method. The multiple variables may include all the variables represented by edges incident on a function node in an FFG representing the dual LP. For example, in the FFG 500, all the variables represented by the outgoing edges 505, 507 and 508 are varied in a single iteration such that the dual cost function is not decreased. Note that the edge u′_{i,0} may not be varied because u′_{i,0}=−x′ᵢ. Thus, there is only one value for u′_{i,0,} which is the value assigned to u′_{i,0} where u′_{i,0}=−x′ᵢ. Given i ∈ I, let the vector wᵢ denote a vector of length

$${d}_{i} {=}^{Δ} \vert {𝒥}_{i} \vert$$

containing all the variables {u′_{i,j}}_{j∈ℑ}_{ᵢ}. wᵢ is a vector containing all the variables that are updated in a single iteration in the coordinate-ascent method for any function node representing A′. A function hᵢ(wᵢ) may be used to determine values for all the variables in the vector wᵢ such that the cost function shown in the dual LP is not decreased. Equation 9 defines hᵢ(wᵢ) as follows:

$${h}_{i} ( {w}_{i} ) {=}^{Δ} {min}_{{a}_{i} ∈ {A}_{i}} 〈 - {u}_{i}^{′} , {a}_{i} 〉 + {\sum }_{j ∈ 𝒥} {min}_{{b}_{j} ∈ {B}_{j}} 〈 - {v}_{j}^{′} , {b}_{j} 〉 \qquad Equation 9$$

hᵢ(wᵢ) represents the portion of the dual cost function that is affected by varying the variables in the vector wᵢ. A solution to hᵢ(wᵢ) is a point where hᵢ(wᵢ) is maximized. In particular, hᵢ(wᵢ) is maximized at any of the following (dᵢ+1) points and consequently at the convex hull of them:

c,

d(1,0, . . . ,0)+c,

d(0,1, . . . ,0)+c, and

d(0,0, . . . ,1)+c

c is a vector of length dᵢ with the k-th component equal to

$${c}_{k} {=}^{Δ} {T}_{j ( k ) , 1}^{′} - {T}_{j ( k ) , 0}^{′} .$$

j(k) is the k-th element in ℑᵢ and

$$d {=}^{Δ} ( {λ}_{i} - {\sum }_{{j}^{′} ∈ {𝒥}_{i}} {c}_{{j}^{′}} ) .$$

### Also,

$${T}_{j , 0}^{′} {Δ}_{\underline{\_}} - {min}_{{{b}_{j} ∈ {B}_{i}}_{{b}_{j , i} = 0}} 〈 - {\tilde{v}}_{j} , {\tilde{b}}_{j} 〉 and {T}_{j , 1}^{′} {Δ}_{\underline{\_}} - {min}_{{{b}_{j} ∈ {B}_{i}}_{{b}_{j , i} = 1}} 〈 - {\tilde{v}}_{j} , {\tilde{b}}_{j} 〉 .$$

The vectors \hat{v}ⱼ and \hat{b}ⱼ are the vectors vⱼ and bⱼ respectively where the i-th position has been omitted. hᵢ(wᵢ) is maximized at any of the points (dᵢ+1) listed above and therefore at any point in the convex hull of them. Thus, any of these points may be selected as a solution to the dual cost function. It should be noted that a maximum of hᵢ(wᵢ) can be quickly and efficiently calculated, which in turn provides for faster decoding. Note that in general, any wᵢ where hᵢ(wᵢ) is not decreased compared to its current value, and not just points where hᵢ(wᵢ) is maximized, can be used as a solution.

As described above, the coordinate-ascent method simultaneously varies multiple variables in each iteration instead of varying a single variable in each iteration. The multiple variables are associated with a function node in the FFG 500. In one embodiment, a set of multiple variables associated with one of the function nodes is randomly selected for each iteration of the coordinate-ascent method, which may improve decoding time.

In Equation 9, wi is a vector containing all the variables that are updated in a single iteration in the coordinate-ascent method for any function node representing A′ᵢ. Multiple variables may be varied in a single iteration for nodes in the FFG 500 representing B′ⱼ (e.g., the node 503). These variables include the outgoing edges of the node 503. Equation 10 described below defines a function hⱼ(wⱼ) for determining values for all the variables in the vector wⱼ such that the cost function shown in the dual LP is not decreased, where wⱼ is a vector containing all the variables that are updated in a single iteration in the coordinate-ascent method for any function node representing B′ⱼ. Equation 10 defines hⱼ(wⱼ) as follows:

$${h}_{j} ( {w}_{j} ) {=}^{Δ} {min}_{{b}_{j} ∈ {B}_{j}} 〈 - {v}_{j}^{′} , {b}_{j} 〉 + {\sum }_{i ∈ {I}_{j}} {min}_{{a}_{i} ∈ {A}_{i}} 〈 - {u}_{i}^{′} , {a}_{i} 〉 \qquad Equation 10$$

Equation 10 is used to update all the variables corresponding to outgoing edges for a function node B′ⱼ. Assume that the function node B′ⱼ has degree k, then IⱼΔ{i₁, . . . iₖ} and wⱼ={u′ᵢ_{₁}_{,j},u′ᵢ_{₂}_{,j} . . . u′ᵢ_{ₖ}_{,j}}. It can easily be shown that the set of wⱼ's that maximizes hⱼ(wⱼ) is a convex set, however, this set is rather complicated to described as opposed to the set of points derived for maximizing Equation 9. Thus, the following describes one point in the set that maximizes hⱼ(wⱼ), which generally lies in the middle of the set. The following notations are used: |λ| denotes the absolute value of λ;

$$\begin{matrix}+ 1 & if & {λ}_{{i}_{𝓁}} > 0 \\ {s}_{{i}_{𝓁}} {Δ}_{\underline{\_}} 0 & if & {λ}_{{i}_{𝓁}} = 0 \\ - 1 & if & {λ}_{{i}_{𝓁}} < 0\end{matrix}$$

denotes the sign of λᵢ_{ₗ},l=1, . . . ,k; and

$$s {Δ}_{\underline{\_}} {\prod }_{i ∈ {I}_{j}} {s}_{{i}_{𝓁}} .$$

Moreover, λᵢ_{ₗ},l=1, . . . ,k are ordered such that |λᵢ_{₁}|≦|λᵢ_{₂}|≦ . . . ≦|λᵢ_{ₖ}|. Then, this middle point is given by the following:

$${u}_{{i}_{1}}^{′} = {s}_{{i}_{1}} \cdot ( \frac{2}{3} \vert {λ}_{{i}_{1}} \vert - \frac{1}{3} s \cdot \vert {λ}_{{i}_{2}} \vert ) , {u}_{{i}_{2}}^{′} = {s}_{{i}_{2}} \cdot ( \frac{1}{2} \vert {λ}_{{i}_{2}} \vert - \frac{1}{2} s \cdot {s}_{1} \cdot {u}_{{i}_{1}}^{′} ) , \\ {u}_{{i}_{3}}^{′} = {s}_{{i}_{3}} \cdot ( \frac{1}{2} \vert {λ}_{{i}_{3}} \vert - \frac{1}{2} s \cdot {s}_{1} \cdot {u}_{{i}_{1}}^{′} ) , … , {u}_{{i}_{k}}^{′} = {s}_{{i}_{k}} \cdot ( \frac{1}{2} \vert {λ}_{{i}_{k}} \vert - \frac{1}{2} s \cdot {s}_{1} \cdot {u}_{{i}_{1}}^{′} ) .$$

Note that formulations for u′ᵢ_{₂} . . . u′ᵢ_{ₖ} are nearly identical. Also, instead of the one point in the set that maximizes hⱼ(wⱼ) described above, note that generally any wⱼ can be chosen such that the function hⱼ(wⱼ) is not decreased.

A solution to the dual LP in Equation 8 can be used to derive a solution to the primal LP in Equation 7. The codeword estimate \hat{x} is set according to Equation 11 as follows:

$$\begin{matrix}0 & if & 〈 - {u}_{i}^{′} , {a}_{i} 〉 {\vert}_{{a}_{i} = ( 0 , … , 0 )} < 〈 - {u}_{i}^{′} , {a}_{i} 〉 {\vert}_{{a}_{i} = ( 1 , … , 1 )} \\ {\hat{x}}_{i} {Δ}_{\underline{\_}} ? & if & 〈 - {u}_{i}^{′} , {a}_{i} 〉 {\vert}_{{a}_{i} = ( 0 , … , 0 )} = 〈 - {u}_{i}^{′} , {a}_{i} 〉 {\vert}_{{a}_{i} = ( 1 , … , 1 )} \\ 1 & if & 〈 - {u}_{i}^{′} , {a}_{i} 〉 {\vert}_{{a}_{i} = ( 0 , … , 0 )} > 〈 - {u}_{i}^{′} , {a}_{i} 〉 {\vert}_{{a}_{i} = ( 1 , … , 1 )}\end{matrix} \qquad Equation 11$$

As described in Equation 11, \hat{x}ᵢ equals 0 if [symbol] −u′ᵢ,aᵢ [symbol] |ₐ_{ᵢ}_{=(0, . . . ,0)}< [symbol] −u′ᵢ,aᵢ [symbol] |ₐ_{ᵢ}_{=(1, . . . ,1)} and \hat{x}ᵢ equals 1 if [symbol] −u′ᵢ,aᵢ [symbol] |ₐ_{ᵢ}_{=(0, . . . ,0)}> [symbol] −u′ᵢ,aᵢ [symbol] |ₐ_{ᵢ}_{=(1, . . . ,1)}. \hat{x}ᵢ=? if. The “?” means that the decoder is unable to determine whether the bit \hat{x}ᵢ is a 0 or 1. Then, retransmission or a re-read may be performed.

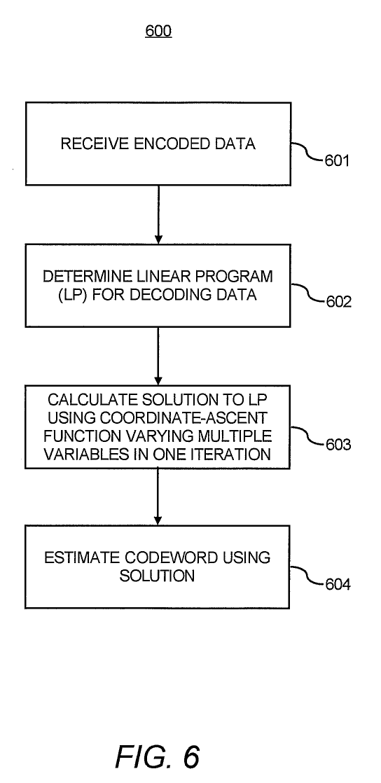

FIG. 6 illustrates a flow chart of a method 600 for decoding data, according to an embodiment. FIG. 6 may be described with respect to FIGS. 1-5 by way of example and not limitation.

At step 601, encoded data is received. For example, encoded data y shown in FIG. 1 is received by the decoder 104.

At step 602, an LP is determined for decoding the received data. The LP is described in Equations 6 and 7. The LP includes a cost function associated with a probability that a particular word was received given that a particular codeword was sent over the communication channel. The LP is formulated as a dual LP shown in Equation 8, and the LP at step 602 may include this dual LP.

At step 603, a solution to the LP from step 602 is determined using a coordinate-ascent method that varies multiple variables associated with the cost function in one iteration. For example, for any A′ᵢ Equation 9 is solved to improve the solution of the dual LP. For any B′ⱼ, Equation 10 is solved to improve the solution of the dual LP. A solution that maximizes hᵢ(wᵢ) and a respective hⱼ(wⱼ) may be selected.

At step 604, a transmitted codeword is estimated from the received encoded data using the solutions from step 603. Equation 11 describes converting the solution to an estimation of the transmitted codeword.

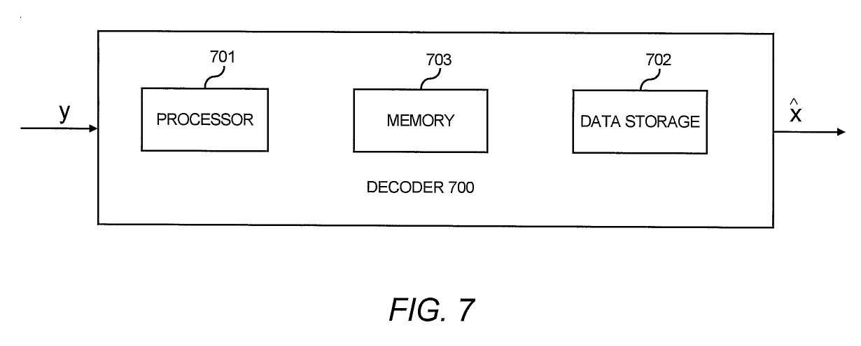

FIG. 7 illustrates an exemplary block diagram of a decoder 700, according to an embodiment. The decoder 700 includes one or more processors, such as processor 701, providing an execution platform for executing software. The decoder 700 also includes data storage 702 for storing data received over a communication channel, such as the data y shown in FIG. 1. The processor 701 is operable to decode the received data as described with respect to the method 600 and other steps described above. The decoder 700 includes a memory 703 where software may be resident during runtime. The software may embody the steps described above for decoding data.

In particular, the method 600 and other steps described herein may be implemented as software embedded on a computer readable medium, such as the memory 703 and executed by a processor, such as the processor 701. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It will be apparent to one of ordinary skill in the art that the decoder 700 is meant to illustrate a generic decoder, and many conventional components that may be used in the decoder 700 are not shown.

While the embodiments have been described with reference to examples, those skilled in the art will be able to make various modifications to the described embodiments without departing from the scope of the claimed embodiments.

What is claimed is:

1. A method of decoding codes representing data received in a communication system, the method comprising:
receiving encoded data representing a codeword transmitted on a communication channel in the communication system;
determining a linear program (LP) for decoding the received data, wherein the linear program includes a cost function associated with a probability that a particular word is received when a particular codeword was sent over the communication channel;
calculating a solution to the LP using a coordinate-ascent method that varies multiple variables associated with the cost function in one iteration; and
estimating a transmitted codeword from the received encoded data using the solution to the LP.

2. The method of claim 1, wherein determining a linear program comprises:
determining a dual LP from the LP, wherein the LP is a primal LP and the dual LP includes a dual cost function and constraints derived from the cost function and constraints in the primal LP; and
calculating a solution to the LP comprises solving the dual LP by optimizing the dual cost function when calculating a solution to the dual.

3. The method of claim 2, wherein optimizing the dual cost function comprises:
determining a solution to the dual LP such that the dual cost function is maximized with respect to the constraints.

4. The method of claim 2, wherein the dual cost function is representable by a Forney-style factor graph with function nodes representing local functions, which are summands, of the dual cost function and edges connected to each function node representing variables for the respective function, and solving the dual LP comprises:
selecting the multiple variables, wherein the multiple variables include variables represented by edges incident to a particular function node of the function nodes.

5. The method of claim 4, wherein the particular function node represents either a function A′ᵢ or B′ⱼ, where A′ᵢ in the dual LP is a dual function of an equality function node Aᵢ in the primal LP, and where B′ⱼ in the dual LP is a dual function of a parity-check node Bⱼ in the primal LP.

6. The method of claim 5, wherein selecting the multiple variables comprises:
randomly selecting an A′ᵢ function node or B′ⱼ function node; and
updating variables associated with the incident edges for the randomly selected function node.

7. The method of claim 2, wherein part of the dual cost function is representable by
$${h}_{i} ( {w}_{i} ) {=}^{Δ} {min}_{{a}_{i} ∈ {A}_{i}} 〈 - {u}_{i}^{′} , {a}_{i} 〉 + {\sum }_{j ∈ {J}_{i}} {min}_{{b}_{j} ∈ {B}_{j}} 〈 - {v}_{j}^{′} , {b}_{j} 〉 ,$$
where u′ᵢ and vⱼⁱ are variables in the cost function and wᵢ represents the multiple variables, and solving the dual LP comprises:
determining a solution where hᵢ(wᵢ) is maximized.

8. The method of claim 2, wherein part of the dual cost function is representable by
$${h}_{j} ( {w}_{j} ) {=}^{Δ} {min}_{{b}_{j} ∈ {B}_{j}} 〈 - {v}_{j}^{′} , {b}_{j} 〉 + {\sum }_{i ∈ Ij} {min}_{{a}_{i} ∈ {A}_{i}} 〈 - {u}_{i}^{′} , {a}_{i} 〉$$
and solving the dual LP comprises:
determining a solution where hⱼ(wⱼ) is maximized.

9. The method of claim 2, wherein determining a dual LP comprises:
determining a fundamental polytope including a set of solutions minimizing the cost function in a primal LP; and
determining the dual LP from the primal LP.

10. The method of claim 9, wherein the data is encoded using codewords from a code C that is described by a parity-check matrix H, wherein codewords having a number of codeword bits comprised of information bits and parity check bits, wherein a product of any of the codewords and the predetermined parity-check matrix H is zero, and
wherein the relaxed polytope contains the codewords as a subset.

11. The method of claim 1, wherein the solution to the LP approximates a decoding result of a decoder that minimizes a probability of incorrectly estimating the transmitted codeword.

12. A decoder operable to decode received data transmitted on a noisy communication channel, the decoder comprising:
a memory storing bits of encoded data received over the communication channel; and
a processor estimating a transmitted codeword from the received bits, wherein the processor is operable to estimate the transmitted codeword by
determining a linear program (LP) for decoding the received data, wherein the linear program includes a cost function associated with a probability that a particular word is received when a particular codeword was sent over the communication channel;
calculating a solution to the LP using a coordinate-ascent method that varies multiple variables associated with the cost function in one iteration; and
estimating a transmitted codeword from the received encoded data using the solution to the LP.

13. The decoder of claim 12, wherein the processor formulates the LP as a dual LP including a dual cost function and determines a solution to the dual LP.

14. The decoder of claim 13, wherein the dual cost function is representable by a Forney-style factor graph with function nodes representing local functions, which are summands, in the dual cost function and edges connected to each function node representing variables for the respective function, and the multiple variables include variables represented by the edges incident to a particular function node.

15. The decoder of claim 14, wherein the particular function node represents either a function A′ᵢ or B′ⱼ, where A′ᵢ in the dual LP is a dual function of an equality function node Aᵢ in the primal LP, and where B′ⱼ in the dual LP is a dual function of a parity-check node Bⱼ in the primal LP.

16. The decoder of claim 15, wherein the particular function node is randomly selected.

17. The decoder of claim 14, wherein part of the dual cost function is representable by
$${h}_{i} ( {w}_{i} ) {=}^{Δ} {min}_{{a}_{i} ∈ {A}_{i}} 〈 {u}_{i}^{′} , {a}_{i} 〉 + {\sum }_{j ∈ {J}_{i}} {min}_{{b}_{j} ∈ {B}_{j}} 〈 - {v}_{j}^{′} , {b}_{j} 〉 ,$$
where u′ᵢ and v′ᵢ are variables in the cost function and wᵢ represents the multiple variables, and the processor is operable to determine a solution to the dual LP where hᵢ(wᵢ) is maximized.

18. The decoder of claim 14, wherein part of the dual cost function is representable by
$${h}_{j} ( {w}_{j} ) {=}^{Δ} {min}_{{b}_{j} ∈ {B}_{j}} 〈 - {v}_{j}^{′} , {b}_{j} 〉 + {\sum }_{i ∈ Ij} {min}_{{a}_{i} ∈ {A}_{i}} 〈 - {u}_{i}^{′} , {a}_{i} 〉$$
where u′ᵢ and v′ⱼ are variables in the cost function and wⱼ represents the multiple variables, and the processor is operable to determine a solution to the dual LP where hⱼ(wⱼ) is maximized.

19. The decoder of claim 12, wherein the data transmitted on the noisy channel comprises LDPC codes.

20. A decoder operable to decode transmitted codes received over a noisy communication channel, wherein the transmitted codes represent. codewords used to encode data from a source, the decoder comprising:
a memory storing bits of encoded data received over the communication channel; and
a processor estimating a transmitted codeword from the received bits, wherein the processor is operable to estimate the transmitted codeword by
determining a cost function and constraints for a primal LP, wherein the cost function is associated with a probability that a particular word is received when a particular codeword was sent over the communication channel;
formulating a cost function and constraints of a dual LP from the cost function and the constraints of the primal LP;
calculating a solution to the dual LP using a coordinate-ascent method that varies multiple variables associated with the cost function in one iteration, wherein the solution is a solution where the cost function is maximized; and
estimating a transmitted codeword from the received encoded data using the solution.
